(19) United States
(12) Patent Application Publication
(10) Pub. No.: US 2003/0046069 A1
(43) Pub. Date: Mar. 6, 2003

(54) Noise reduction system and method

(76) Inventor: Julien Rivarol Vergin, Seattle, WA (US)

Correspondence Address: BLACK LOWE & GRAHAM PLLC, 816 Second Avenue, Seattle, WA, 98104, US

(21) Appl. No.: 10/024,446

(22) Filed: Dec. 17, 2001

Related U.S. Application Data
(60) Provisional application No. 60/315,806, filed on Aug. 28, 2001.

(51) Int. Cl. G10L 21/02

(52) U.S. Cl. 704/228

(57) ABSTRACT

A system, method and computer program product for performing noise reduction. The system receives a sound signal determined to include speech, then estimates a noise value of the received sound signal. Next, the system subtracts the estimated noise value from the received signal, generates a prediction signal of the result of the subtraction, and sends the generated prediction signal to a speech recognition engine.

### FIELD OF THE INVENTION

This invention relates generally to user interfaces and, more specifically, to speech recognition systems.

### BACKGROUND OF THE INVENTION

The sound captured by a microphone is the sum of many sounds, including vocal commands spoken by the person talking plus background environmental noise. Speech recognition is a process by which a spoken command is translated into a set of specific words. To do that, a speech recognition engine compares an input utterance against a set of previously calculated patterns. If the input utterance matches a pattern, the set of words associated with the matched pattern is recognized. Patterns are typically calculated using clean speech data (speech without noise). During the comparison phase of recognition, any input speech utterance containing noise is usually not recognized.

In a quiet environment, there is little need for noise reduction because the input is usually sufficiently clean to allow for adequate pattern recognition. However, in a high noise environment, such as a motor vehicle, extraneous noise will undoubtedly be added to spoken commands. This will result in poor performance of a speech recognition system. Various methods have been attempted to reduce the amount of noise that is included with spoken commands when input into a speech recognition engine. One method attempts to eliminate extraneous noise by providing sound recordation at two microphones. The first microphone records the speech from the user, while a second microphone is placed at some other position in that same environment for recording only noise. The noise recorded from the second microphone is subtracted from the signal recorded at the first microphone. This process is sometimes referred to as spectral noise reduction. This works well in many environments, but in a vehicle the relatively small distance between the first and second microphones will result in some speech being recorded at the second microphone. As such, speech may be subtracted from the recordation from the first microphone recording. Also, in a vehicle, the cost of running more wire for a second microphone outweighs any benefit provided by the second microphone.

In another example, only a single microphone is used. In this example, a signal that is recorded when the system is first started is assumed to be only noise. This is recorded and subtracted from the signal once speech is begun. This type of spectral noise reduction assumes that the noise is predictable over time and does not vary much. However, in a dynamic noise environment such as a vehicle, the noise is unpredictable, for example, car horns, sirens, passing trucks, or vehicle noise. As such, noise that is greater than the initial recorded noise may be included in the signal sent to the speech recognition engine, thereby causing false speech analysis based on noise.

Therefore, there exists a need to remove as much environmental noise from the input speech data as possible to facilitate accurate speech recognition.

### SUMMARY OF THE INVENTION

The present invention comprises a system, method and computer program product for performing noise reduction. The system receives a sound signal determined to include speech, then estimates a noise value of the received sound signal. Next, the system subtracts the estimated noise value from the received signal, generates a prediction signal of the result of the subtraction, and sends the generated prediction signal to a speech recognition engine.

In accordance with further aspects of the invention, the system generates a prediction signal based on a linear prediction algorithm.

In accordance with other aspects of the invention, first, the system generates a prediction signal of the received signal, then subtracts the estimated noise value from the generated prediction signal, and sends the result of the subtraction to a speech recognition engine.

As will be readily appreciated from the foregoing summary, the invention provides improved noise reduction processing of speech signals being sent to a speech recognition engine.

### BRIEF DESCRIPTION OF THE DRAWINGS

The preferred and alternative embodiments of the present invention are described in detail below with reference to the following drawings.

FIG. 1 is an example system formed in accordance with the present invention;

FIGS. 2 and 3 are flow diagrams of the present invention; and

FIG. 4 is a time domain representation of spoken words.

### DETAILED DESCRIPTION OF THE PREFERRED EMBODIMENT

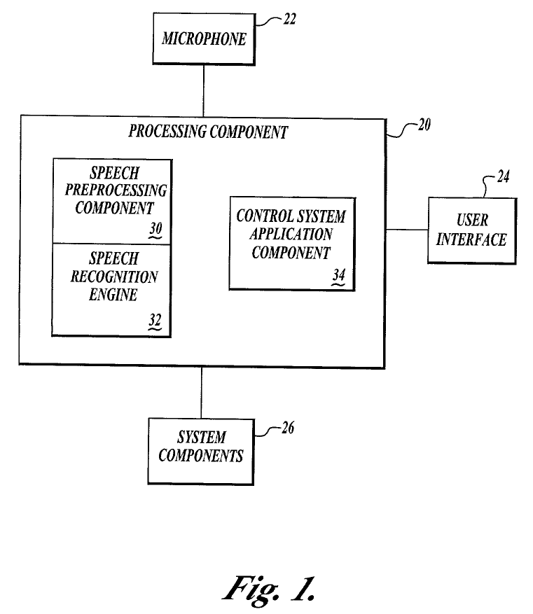

The present invention provides a system, method, and computer program product for performing noise reduction in speech. The system includes a processing component 20 electrically coupled to a microphone 22, a user interface 24, and various system components 26. If the system shown in FIG. 1 is implemented in a vehicle, examples of some of the system components 26 include an automatic door locking system, an automatic window system, a radio, a cruise control system, and other various electrical or computer items that can be controlled by electrical commands. Processing component 20 includes a speech preprocessing component 30, a speech recognition engine 32, a control system application component 34, and memory (not shown).

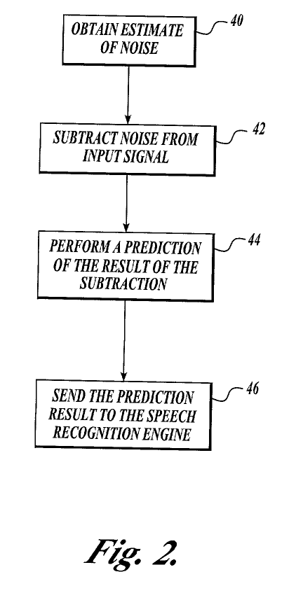

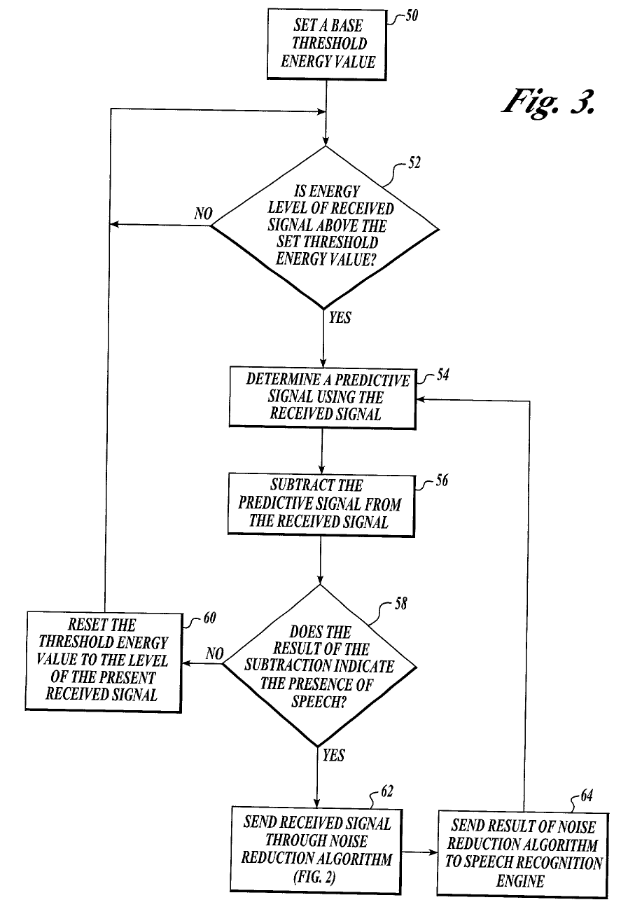

Speech preprocessing component 30 performs a preliminary analysis of whether speech is included in a signal received from the microphone 20, as well as performs noise reduction of a sound signal that includes speech. If speech preprocessing component 30 determines that the signal received from microphone 22 includes speech, then it performs noise reduction of the received signal and forwards the noise-reduced signal to speech recognition engine 32. The process performed by speech preprocessing component 30 is illustrated and described below in FIGS. 2 and 3. When speech recognition engine 32 receives the signal from speech preprocessing component 30, the speech recognition engine analyzes the received signal based on a speech recognition algorithm. This analysis results in signals that are interpreted by control system application component 34 as instructions used to control functions at a number of system components 26 that are coupled to processing component 20. The type of algorithm used in speech recognition engine 32 is not the primary focus of the present invention, and could consist of any number of algorithms known to the relevant technical community. The method by which speech preprocessing component 30 filters noise out of a received signal from microphone 22 is described below in greater detail.

FIG. 2 illustrates a process for performing spectrum noise subtraction according to one embodiment of the present invention. At block 40, a sampling or estimate of noise is obtained. One embodiment for obtaining an estimate of noise is illustrated in FIG. 3 and, in an alternate embodiment, described below. At block 42, the obtained estimate of noise is subtracted from the input signal (i.e., the signal received by microphone 22 and sent to processing component 20). At block 44, the prediction of the result of the subtraction from block 42 is generated. The prediction is preferably generated using a linear prediction-coding algorithm. When a prediction is performed on a signal that includes speech and noise, the result is a signal that includes primarily speech. This is because a prediction performed on the combined signal will enhance a highly correlative signal, such as speech, and will diminish a less correlated signal, such as noise. At block 46, the prediction signal is sent to the speech recognition engine for processing.

In an alternate embodiment, a prediction of the input signal is generated prior to the subtraction of the obtained noise estimate. The result of this subtraction is then sent to speech recognition engine 32.

FIG. 3 illustrates a process performed in association with the process shown in FIG. 2. At block 50, a base threshold energy value or estimated noise signal is set. This value can be set in various ways. For example, at the time the process begins and before speech is inputted, the threshold energy value is set to an average energy value of the received signal. The initial base threshold value can be preset based on a predetermined value, or it can be manually set.

At decision block 52, the process determines if the energy level of received signal is above the set threshold energy value. If the energy level is not above the threshold energy value, then the received signal is noise (estimate of noise) and the process returns to the determination at decision block 52. If the received signal energy value is above the set threshold energy value, then the received signal may include noise. At block 54, the process generates a predictive signal of the received signal. The predictive signal is preferably generated using a linear predictive coding (LPC) algorithm. An LPC algorithm provides a process for calculating a new signal based on samples from an input signal. An example LPC algorithm is shown and described in more detail below.

At block 56, the predictive signal is subtracted from the received signal. Then, at decision block 58, the process determines if the result of the subtraction indicates the presence of speech. The result of the subtraction generates a residual error signal. In order to determine if the residual error signal shows that speech is present in the received signal, the process determines if the distances between the peaks of the residual error signal are within a preset frequency range. If speech is present in the received signal, the distance between the peaks of the residual error signal is in a frequency range that indicates the vibration time of ones vocal cords. An example frequency range (vocal cord vibration time) for analyzing the peaks is 60 Hz-500 Hz. An autocorrelation function determines the distance between consecutive peaks in the error signal.

If the subtraction result fails to indicate speech, the process proceeds to block 60, where the threshold energy value is reset to the level of the present received signal, and the process returns to decision block 52. If the subtraction result indicates the presence of speech, the process proceeds to block 62, where it sends the received signal to a noise reduction algorithm, such as that shown in FIG. 2. The estimate of noise used in the noise reduction algorithm is equivalent to the set or reset threshold energy value. At block 64, the result of the noise reduction algorithm is sent to a speech recognition engine. Because noise is experienced dynamically, the process returns to the block 54 after a sample period of time has passed.

The following is an example LPC algorithm used during the step at blocks 44 and 54 to generate a predictive signal \overline{x(n)}. Defining \overline{x(n)} as an estimated value of the received signal x(n−k) at time n, \overline{x(n)} can be expressed as:

$$\overline{x ( n )} = {\sum }_{k = 1}^{K} a ( k ) * x ( n - k )$$

The coefficients a(k), k=1, . . . , K, are prediction coefficients. The difference between x(n) and \overline{x(n)} is the residual error, e(n). The goal is to choose the coefficients a(k) such that e(n) is minimal in a least-quares sense. The best coefficients a(k) are obtained by solving the following K linear equation:

$${\sum }_{k = 1}^{K} a ( k ) * R ( i - k ) = R ( i ) , \text{for} i = 1 , … , K$$

where R(i), is an autocorrelation function:

$$R ( i ) = {\sum }_{n = i}^{N} x ( n ) * x ( n - i ) , \text{for} i = 1 , … , K$$

These sets of linear equations are preferably solved using the Levinson-Durbin recursive procedure technique.

The following describes an alternate embodiment for obtaining an estimate of noise value \overline{N(k)} when speech is assumed or determined to be present.

A phoneme is the smallest, single linguistic unit that can convey a distinction in meaning (e.g., m in mat; b in bat). Speech is a collection of phonemes that, when connected together, form a word or a set of words. The slightest change in a collection of phonemes (e.g., from bat to vat) conveys an entirely different meaning. Each language has somewhere between 30 and 40 phonemes. The English language has approximately 38.

Some phonemes are classified as voiced (stressed), such as /a/, /e/, and /o/. Others are classified as unvoiced (unstressed), such as /f/ and /s/. For voiced phonemes, most of the energy is concentrated at a low frequency. For unvoiced phonemes, energy is distributed in all frequency bands and looks to a recognizer more like a noise than a sound. Like unvoiced phonemes, the signal energy for unvoiced sounds (such as the hiss when an audio cassette is being played) is also lower than voiced sound.

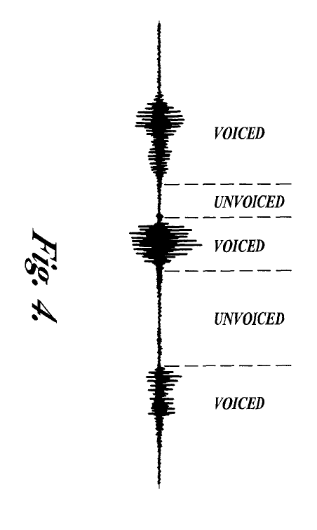

FIG. 4 illustrates the recognizer's representation of the phrase “Wingcast here” in the time domain. It appears that unvoiced sounds are mostly noise. When the input signal is speech, the following occurs to update the noise estimate.

If the part of the speech being analyzed is unvoiced, we conclude that

\overline{N(k)}=0.75*Y(k)

Where Y(k) is the power spectral energy of the current input window data. An example size of a window of data is 30 milliseconds of speech. If the part of the speech being analyzed is voiced, then \overline{N(k)} remains unchanged.

With voiced sounds, most of the signal energy is concentrated at lower frequencies. Therefore, to differentiate between voiced and unvoiced sounds, we evaluate the maximum amount of energy, EF1, in a window of 300 Hz in intervals between 100 Hz and 1000 Hz. This is the equivalent of evaluating the concentration of energy in the First Formant. We compare EF1 with the total signal energy (ETotal), that is, we define Edif as equal to:

$$Edif = \frac{EF1}{ETotal}$$

If Edif is less than α, then we can conclude that the part of speech being analyzed is unvoiced. In our implementation, α=0.1. This algorithm for classifying voiced and unvoiced speech works with 98% efficiency.

When the input data is not speech, then the noise estimated \overline{N(k)} is equal to Y(k). When the input data is speech, if the signal window being analyzed is unvoiced, then we conclude that

\overline{N(k)}=0.75*Y(k)

The estimated energy spectra of the desired signal is given as

\overline{S(k)}=Y(k)−0.5*\overline{N(k)}

This operation is followed by a return in the time domain using IFT. This algorithm works well because \overline{N(k)} is updated regularly. The noise estimated \overline{N(k)} above is then used in the process shown in FIG. 2. The classification of voiced and unvoiced speech is preferably performed in the frequency domain, the signal subtraction also is performed in the frequency domain. Before the signal is sent to the speech recognition engine it is returned to the time domain.

While the preferred embodiment of the invention has been illustrated and described, as noted above, many changes can be made without departing from the spirit and scope of the invention. Accordingly, the scope of the invention is not limited by the disclosure of the preferred embodiment.

The embodiments of the invention in which an exclusive property or privilege is claimed are defined as follows:

1. A noise reduction method comprising:
receiving a sound signal determined to include speech;
estimating a noise value of the received sound signal;
subtracting the estimated noise value from the received signal;
performing noise reduction of the result of the subtraction based on linear prediction algorithm; and
sending the result of the performed noise reduction to a speech recognition engine.

2. A noise reduction method comprising:
receiving a sound signal determined to include speech;
estimating a noise value of the received sound signal;
performing noise reduction of the received signal based on linear prediction algorithm;
subtracting the estimated noise value from the result of the performed noise reduction; and
sending the result of the subtraction to a speech recognition engine.

3. A noise reduction system comprising:
a means for receiving a sound signal determined to include speech;
a means for estimating a noise value of the received sound signal;
a means for subtracting the estimated noise value from the received signal;
a means for performing noise reduction of the result of the subtraction based on linear prediction algorithm; and
a means for sending the result of the performed noise reduction to a speech recognition engine.

4. A noise reduction method comprising:
a means for receiving a sound signal determined to include speech;
a means for estimating a noise value of the received sound signal;
a means for performing noise reduction of the received signal based on linear prediction algorithm;
a means for subtracting the estimated noise value from the result of the performed noise reduction; and
a means for sending the result of the subtraction to a speech recognition engine.

5. A noise reduction computer program product for performing a method comprising:
receiving a sound signal determined to include speech;
estimating a noise value of the received sound signal;
subtracting the estimated noise value from the received signal;
performing noise reduction of the result of the subtraction based on linear prediction algorithm; and
sending the result of the performed noise reduction to a speech recognition engine.

6. A noise reduction computer program product for performing a method comprising:
receiving a sound signal determined to include speech;
estimating a noise value of the received sound signal;
performing noise reduction of the received signal based on linear prediction algorithm;
subtracting the estimated noise value from the result of the performed noise reduction; and
sending the result of the subtraction to a speech recognition engine.
